(19) United States
(12) Patent Application Publication
(10) Pub. No.: US 2012/0125231 A1
(43) Pub. Date: May 24, 2012

(54) Coating Formulation

(75) Inventors: Flave Markland, Atkins, IA (US); John Widen, Minneapolis, MN (US); Nikola A. Nikolic, Cedar Rapids, IA (US)

(73) Assignee: PENFORD PRODUCTS CO., Cedar Rapids, IA (US)

(21) Appl. No.: 13/296,924

(22) Filed: Nov. 15, 2011

Related U.S. Application Data
(60) Provisional application No. 61/413,948, filed on Nov. 15, 2010.

(51) Int. Cl. C09D 103/00; C09D 189/00; D21H 23/00; C09D 105/00

(52) U.S. Cl. 106/145.1; 106/135.1; 106/154.11; 106/156.3; 106/161.1; 162/174

(57) ABSTRACT

A coating composition comprising from 5-15% by weight prolamine, from 5 to 15% by weight surfactant and from 70-90% by weight water is provided along with methods of sizing substrates. Particularly preferred are compositions further comprising glyoxal or other crosslinking agents. Also provided are coating compositions comprising from 5 to 30% surfactant by weight with water and an antifoam agent and further comprising a carbohydrate The compositions are optionally applied with additional coating ingredients including carbohydrates including starches as well as binders, minerals and pigments and antifoam agents.

### CROSS-REFERENCE TO RELATED APPLICATIONS

This application is based on U.S. Provisional Application Ser. No. 61/413,948, filed Nov. 15, 2010.

### BACKGROUND OF THE INVENTION

The present invention relates generally to sizing compounds, and particularly to compounds used to provide oil and grease resistance in the paper and textile industries.

The prior art teaches the use of fluorocarbons for providing oil and grease resistance to paper and textile substrates. Unfortunately, there exist environmental and health concerns with the use of fluorocarbons and there is a desire in the art to develop substitutes to sizing compounds as an alternative fluorocarbon chemistry.

Prolamines are of interest to the present invention. Prolamines are plant storage proteins having a high proline content and are found in the seeds of cereal grains. Typical prolamines include zein which is present in corn; gliadin which is present in wheat, hordein which is present in barley and secaline which is present in rye. They are typically characterized by high proline and glutamine contents and are generally soluble only in strong alcohol solutions.

Of interest to the present invention is the disclosure of Cook et al., U.S. Pat. No. 5,705,207 which discloses a coating against water, oil and gas consisting of a prolamine-derived protein and starch in an aqueous acid. Anderson, et al., U.S. Pat. No. 6,231,970 discloses thermoplastic sheets including starch, a protein-based polymer such a zein and a plasticizer such as propylene glycol. Khemanin et al., U.S. Pat. No. 6,573,340 discloses polymer films comprising starch, a prolamine and polyethylene glycol.

Also of interest to the present invention is the disclosure of Jabar, Jr. et al., U.S. Pat. No. 7,737,200 which is directed to an aqueous barrier coating composition comprising (a) prolamine such as zein, (b) a cold water soluble polymer such as an ethylated starch, (c) water, (d) a water-soluble co-solvent such as propylene glycol and (e) a stabilizer such as carboxymethyl cellulose. Such sizing compounds are said to provide an article with a high surface energy and resistance to oil and grease penetration when applied to a substrate.

Of further interest to the present invention is the disclosure of Billmers et al., U.S. Pat. No. 6,790,270 which is directed to the use of octenyl succinic anhydride (OSA) modified starch for making oil and grease resistant paper.

Despite such advances with non-fluorocarbon coatings, there remains an interest in developing further improved sizing compositions which can be used to provide oil and grease resistance to paper, textile and other substrates.

### BRIEF SUMMARY OF THE INVENTION

The present invention is based on the discovery that a sizing composition comprising only the combination of a prolamine, a surfactant and water can provide excellent oil and grease resistance to a paper, textile or other substrate. Kit values are well known for use in measuring the oil and grease resistance of coated and the invention provides a method of providing Kit values of greater than 3 to coated substrates for use in a variety of applications.

Specifically, the invention provides a coating composition comprising from 5-15% by weight prolamine, from 5 to 15% by weight surfactant and from 70-90% by weight water. Such compositions can be combined with starches or other sizing agents and can optionally include other ingredients. One such preferred ingredient is antifoam which is useful to prevent excess foaming caused by the presence of surfactants in the formulation. These components can be applied in combination with other sizing agents such as starches, binders, minerals and pigments to produce substrates with improved oil and grease resistance. A particularly preferred composition for application at a size press comprises from 0.3 to 1.5 percent by weight corn zein, from 0.3 to 1.6 percent by weight sodium dodecyl sulfate (SDS) and from 0.01 to 0.05 percent by weight of an antifoaming agent with the remainder comprising deionized water with the overall pH between 6 and 8.

The prolamine used in accordance with the invention can be derived from a variety of sources but is preferably selected from the group consisting of zein, gliadin, hordein and secalin with zein being particularly preferred. Zein is a commercially available protein but may be obtained from corn gluten meal by methods well understood in the art. According to one such method, corn gluten meal is washed with 100% ethanol multiple times to wash out impurities and color. The “clean” corn gluten meal is then extracted with aqueous alcohol at greater than 50° C. and the extract is concentrated under vacuum.

The solvent containing prolamine can then have SDS surfactant added at a 1:1 ratio and an adequate amount of water added to maintain proper solids and liquid levels. The solvent can then be evaporated to a target level or to yield an essentially aqueous composition. The concentrate will be between 10-30% solids with a small amount of antifoam (usually less than 0.1% w/w) added to improve pouring and transfer.

A variety of surfactants can be used but according to one preferred aspect of the invention the surfactant is an anionic surfactant. Preferred surfactants include those with a hydrophilic-lipophilic balance (HLB) of from 20 to 40. Two particularly preferred surfactants are sodium laureth sulfate and sodium dodecyl sulfate (SDS). According to one aspect of the invention a 1:1 to 1:1.5 weight ratio of zein to SDS is preferred with a ratio of 1:1.1 appearing to be particularly preferred.

According to another aspect of the invention, the coating composition further comprises antifoam. Antifoaming agents include, but are not limited to, water-based silicone emulsions, polyethylene/polypropylene block polymers, glycols, salts of organic acids, organic phosphates. Antifoam is desired in order to prevent foaming promoted by the presence of surfactants during the coating process. Foaming at the size press during application of a sizing composition is already an issue during conventional sizing operations therefore the application of antifoam is particularly important in practice of the present invention.

According to a preferred aspect of the invention a crosslinking agent such as glyoxal is incorporated. While not intending to be bound by any particular theory of the invention it is believed that glyoxal may function to crosslink components of the coating composition including proteins and/or polysaccharides which are present therein.

The coating compositions of the invention preferably further include or are applied with a polysaccharide as polysaccharides such as starches and modified starches are frequently used in the art as coating compositions. Some examples of suitable polysaccharide include starches, starch derivatives, modified starches, thermoplastic starches, starch esters such as starch acetate, starch hydroxyethyl ethers, alkyl starches, phosphate starches and dialdehyde starches. The starch can be cationic, anionic or amphoteric. The starch derivatives include carboxymethyl starch, hydroxyethyl starch, carboxymethylhydroxypropyl starch, oxidized starch and pregelatinized starch. Any of a variety of starches derived from various plant sources may be used including but not limited to corn, waxy-corn, potato, tapioca, rice and sago starch. In addition, biogums, including xanthan, gellan, and other derivatized cellulosic materials may be used.

The compositions of the invention preferably comprise from 1-15% by weight prolamine; from 1-10% by weight surfactant and from 5-25% by weight polysaccharide on a solids basis. Coating compositions for application in a size press more preferably comprise from 6-12% by weight polysaccharide on a solids basis and most preferably about 8-9% by weight. The components of the composition (prolamines and surfactant optionally in the presence of other ingredients including polysaccharides and crosslinking agents) are also particularly useful as additives at the wet end of paper manufacturing machines.

According to another aspect of the invention the starch can be modified starch to further promote oil and grease resistance. Particularly useful modified starches are hydroxyethyl and hydroxypropyl starches which are modified to inhibit retrogradation. Another particularly useful starch is starch hydrophobically modified with octenyl succinic anhydride (OSA) or similar agents such as dodecyl succinic anhydride (DDSA), and the corresponding salts thereof.

According to still a further aspect of the invention, it is contemplated that a stabilizer such as sodium dodecyl sulfate (SDS) or other surfactant may be used in combination with antifoam and water in the absence of prolamine as a sizing agent for combination with carbohydrates such as starch in coating substrates. Thus according to one aspect of the invention a method of coating a substrate is provided comprising the step of applying a coating composition comprising from 5 to 30% by weight surfactant and from 70 to 95% by weight water in further combination with a polysaccharide. The polysaccharide is preferably starch and the surfactant is preferably an anionic surfactant such as sodium dodecyl sulfate (SDS). The compositions also preferably comprise an antifoam agent including, but not limited to those selected from the group consisting of water-based silicone emulsions, polyethylene/polypropylene block polymers, glycols, salts of organic acids, organic phosphates.

The sizing compositions of the invention may be applied to a variety of substrates including, but not limited to those selected from the group consisting of paper, paper board, wood, inorganic substrates and textile products. According to certain aspects of the invention the substrate is paper and the sizing composition is applied during the paper making process, or in a subsequent coating process.

### DETAILED DESCRIPTION OF THE INVENTION

The present invention is directed to improved coating compositions for providing oil and grease resistance to substrates such as paper, paperboard, textiles and the like. According to one aspect the invention provides a water-insoluble prolamine into a dilute, low solids coating composition, such that it can be applied in a size press, while maintaining oil and grease resistance properties. In a second embodiment of the invention the water insoluble prolamine can be delivered in a higher solids content coating formulation. By using sodium dodecyl sulfate (SDS, also referred to as sodium lauryl sulfate) an appropriate amount of prolamine can be solublized/dispersed in an aqueous solution that can then be incorporated into a size press formulation.

The prolamine containing compositions of the invention include corn zein-containing formulations which are functional at low starch solids such as between 7-12% dry solids basis (dsb), pH neutral, and temperature stable up to 150° F. while imparting improved Kit test resistance to the coated sheet. For food wrap optimum Kit values are in a range of 3-4 while items such as microwave popcorn bags, fried chicken buckets and pet-food bags typically require a Kit value of 10 or greater. Other end uses will require different Kit values. The 10-30% total solids include all the solids in the formulation, starch, zein, SDS and defoamer. Stabilizers such as anionic surfactants are used to solubilize and hold the zein in solution long enough to let the starch carry it onto the sheet for deposition, mix well and be compatible in an 100% aqueous, low starch solids environment. The compositions preferably include antifoam compositions to prevent excess foaming resulting from the presence of the surfactant stabilizers. Dow Corning Antifoam B (Antifoam B) emulsion is the preferred antifoam. It contains a distribution of polydimethylsiloxanes in aqueous suspension. A dosage level between 0.02% and 0.1% weight to weight with a preferred level between 0.03% and 0.05% and the most preferred level being 0.04% weight to weight.

According to a preferred aspect of the invention it has been discovered that the incorporation of glyoxal into the coating formulations of the invention provides surprisingly improved oil and grease resistance to those coating formulations. Useful ratios of glyoxal to prolamine range from 0.1:1 to 5:1 by weight (glyoxal:prolamine) with ratios of 0.3:1 to 3:1 by weight being preferred and from 0.5:1 to 1:1 by weight being particularly preferred.

Other protein crosslinking agents include: homobifunctional cross-linkers are used in one-step reactions while the heterobifunctional cross-linkers are used in two-step sequential reactions, where the least labile reactive end is reacted first. Homobifunctional cross-linking agents have the tendency to result in self-conjugation, polymerization, and intracellular cross-linking. On the other hand, heterobifunctional agents allow more controlled two step reactions, which minimizes undesirable intramolecular cross reaction and polymerization.

Other polysaccharide crosslinking agents known to the art include suitable covalent cross-linking agents such as 2,3-dibromopropanol, epichlorohydrin, sodium trimetaphosphate, linear mixed anhydrides or otherwise activated analogues of acetic and di- or tribasic carboxylic acids, vinyl sulfone, diepoxides, cyanuric chloride, hexahydro-1,3,5-trisacryloyl-s-triazine, hexamethylene diisocyanate, toluene 2,4-diisocyanate, N,N-methylenebisacrylamide, N,N′-bis(hydroxymethyl)ethyleneurea, phosphorous(V) oxychloride, phosgene, tripolyphosphate, mixed carbonic-carboxylic acid anhydrides, imidazolides of carbonic and polybasic carboxylic acids, imidazolium salts of polybasic carboxylic acids, guanidine derivatives of polycarboxylic acids, and esters of propanoic acid.

The most widely used heterobifunctional cross-linking agents are used to couple proteins through amine and sulfhydryl groups. The least stable amine reactive NHS-esters couple first and, after removal of uncoupled reagent, the coupling to the sulfhydryl group proceeds. The sulfhydryl reactive groups are generally maleimides, pyridyl disulfides and a-haloacetyls. Other cross-linkers include carbodiimides, which-link between carboxyl groups (—COOH) and primary amines (—NH₂). There are heterobifunctional cross-linkers with one photoreactive end. Photoreactive groups are used when no specific groups are available to react with as photoreactive groups react non-specifically upon exposure to UV light.

Additional crosslinking agents which can be of use in practice of the invention include multifunctional crosslinking agents including difunctional crosslinking agents where the functionalities may be the same or different, although higher functionality may be present, usually not exceeding four functionalities. Stedronsky et al., U.S. Pat. No. 6,423,333 describes a number of crosslinking agents useful for tissue adhesives and sealants. Suitable crosslinking agents will usually be at least about two carbon atoms and not more than about 50 carbon atoms, generally ranging from about 2 to 30 carbon atoms, more usually from about 3 to 16 carbon atoms. The chain joining the two functionalities will be at least one atom and not more than about 100 atoms and usually less than 60, 40 or more preferably 20 atoms where the atoms may be carbon, oxygen, nitrogen; sulfur, phosphorous, or the like. The linking group may be aliphatically saturated or unsaturated, preferably aliphatic, and may include such functionalities as oxy, ester, amide, thioether, amino, and phosphorous ester. The crosslinking group may be hydrophobic or hydrophilic. Stedronsky teaches that various reactive functionalities may be employed, such as aldehyde, isocyanate, mixed carboxylic acid anhydride, e.g. ethoxycarbonyl anhydride, activated olefin, activated halo, amino, and the like. By appropriate choice of the functionalities on the protein polymer, and the crosslinking agent, rate of reaction and degree of crosslinking can be controlled.

Further according to Stedronsky various crosslinking agents may be employed, particularly those which have been used previously and have been found to be physiologically acceptable. Crosslinking agents which may be used include dialdehydes, such as glyoxal and glutaraldehyde, activated diolefins, diisocyanates such as, tetramethylene diisocyanate, hexamethylene diisocyanate, octamethylene diisocyanate, acid anhydrides, such as succinic acid dianhydride, ethylene diamine tetraacetic acid dianhydride, diamines, such as hexamethylene diamine, cyclo(L-lysyl-L-lysine) and the like. The crosslinking agent may also contain unsymmetrical functionalities, for example, activated olefin aldehydes, e.g. acrolein and quinoid aldehydes, activated halocarboxylic acid anhydride, and the like. The crosslinking agents will usually be commercially available or may be readily synthesized in accordance with conventional ways, either prior to application, or by synthesis in situ.

The optimum degree of crosslinking, may be readily determined by those of ordinary skill in the art by empirical means. In this manner, optimum levels of crosslinking agents (or treatments) may be incorporated into the compositions in accord with the known activities of the art-recognized crosslinking agents.

Preferred oil and grease resistant (OGR) coating formulations can be formed comprising a prolamine, a surfactant, water and a crosslinking agent with glyoxal being a preferred crosslinking agent.

The oil and grease resistant coating formulation is frequently combined with a polysaccharide such as starch or a modified starch. A preferred OGR formula comprises from 7-10% by weight corn zein (dsb); from 0.004-0.005% NaOH; from 2.5-30% glyoxal, and from 7.7-11% sodium dodecyl sulfate with the balance water. A more particularly preferred composition useful for a size press applications such as for the production of food wrappers comprises 10% corn zein (dsb), 0.005% NaOH, 5% glyoxal, 11% sodium dodecyl sulfate with the balance water.

According to this method an alcohol solution of zein is prepared and sodium hydroxide is added to the solution to raise its pH. Glyoxal is then added at an amount from 0.5 to 3 times the mass of zein and the composition is stirred at 60° C. for an hour before the addition of a sodium dodecyl sulfate/water solution. The alcohol is then evaporated leaving an aqueous solution at 20% solids.

Formulations of the present invention can then be coated onto a standard base-sheet to provide for oil and grease resistance. While prolamines have been shown to impart oil and grease resistance in paper products, it is surprising that, the presence of significant amounts of surfactants with a prolamine does not appear to reduce oil and grease resistance in the resulting coated product. As a further aspect of the invention, the application of a surfactant only aqueous formulation lacking a prolamine provides oil and grease resistance.

Testing for oil and grease resistance involves using a Gardco Automatic drawdown machine to create a 60 μm film upon a lightweight, uncoated sheet of paper. This film typically contains the starch and zein/SDS formulation, coating a specific area with a uniform thickness which is allowed to dry completely before further testing.

The base sheets are tested for oil and grease resistance using the TAPPI T-559 test which is also known as the 3M Kit test and measures the resistance to oil, grease and solvent penetration of materials treated with these formulations. The test solutions contain varying ratios of three different solvents rated from 1 to 12; 1 being the least oil and grease resistant and 12 being the most resistant. A coated sheet is placed on a clean, flat surface and a drop of test solution is released from a height of 25mm onto the sheet that has been coated with the composition. After 15 seconds, the excess fluid is wiped away and the wetted area is examined. A darkening or spotting of the sheet indicates a failure. The Kit Rating is the highest numbered solution that stands on the surface without causing a failure. Kit testing has a standard error of ±1. A value of 3 to 4 is the target value for a food wrapper applications.

### EXAMPLE 1

According to this example, zein was dissolved in sodium dodecyl sulfate (SDS) using 10 g zein from Sigma Chemical plus 90 g of 5% w/w sodium dodecyl sulfate (SDS) from Sigma Aldrich in water, stirred at 55° C. for 10 minutes and then allowed to cool to room temperature. The fluid was uniform and the protein was fully dissolved in solution.

The optimum balance of zein to SDS was explored along with the proper starch solids to promote adequate pickup and uniform coverage of the test sheet. Drawdowns on lightweight, unsized paper were used to evaluate the materials. A series of tests were conducted that showed a definite trend regarding zein content, SDS concentration and resulting Kit test values as set out below in Table 1. These data show the usefulness of zein to provide oil and grease resistance with less surfactant use which has advantages I the processability of the formulation. The zein also provides film forming and/or mechanical strength to the coated substrate.

Penford Gums are hydroxyethyl-functionalized starches that provide film-forming and water holding benefits. A preferred Penford gum is Penford® Gum 270 (PG270) wherein the trade name indicates the level of ethylation and the viscosity under defined conditions that result after gelatinization.

TABLE 1

| | Total | | | |
|---|---|---|---|---|
| | Solids | Pickup | | Kit Test |
| Formulation | (%) | lbs/3000 ft² | g/m² | (pass) |
| PG 270 starch only | 8.16 | 2.88 | 4.68 | 1 |
| PG 270 starch + 0.50% SDS | 8.91 | 2.80 | 4.57 | 1 |
| PG 270 starch + 1.00% SDS | 9.14 | 3.14 | 5.1 | 4 |
| PG 270 starch + 0.80% Zein + 0.25% SDS | 8.53 | 3.11 | 5.07 | 2 |
| PG 270 starch + 1.60% Zein + 0.50% SDS | 9.04 | 2.99 | 4.87 | 4 |
| PG 270 + 5.40% Zein/IPA Extract Only, no SDS | 9.32 | 2.89 | 4.72 | 2 |
| PG 270 + 5.40% Zein + 6.50% SDS | 13.52 | 2.75 | 4.47 | 10 |
| PG 270 + 5.40% Zein + 6.50% SDS + Antifoam B | 13.79 | 3.02 | 4.92 | 10 |

### EXAMPLE 2

According to this example, a second coating study was conducted and revealed similar results in Table 2 below: A coating was prepared with cooked PG270 at 7.81% solids and different amounts of Zein/SDS concentrate at 35.89% solids were added together up to a total weight of 100 g. The amount of starch added was lowered to account for the increasing levels of concentrate. Penford® Gum 380 (PG380) is a hydroxyethylated starch with a higher degree of substitution than Penford® Gum 270 (PG270). The coatings were prepared the same as with the PG270 samples.

TABLE 2

| | | Pickup | | |
|---|---|---|---|---|
| | % | lbs/ | | Kit |
| Formulation | Solids | 3000 ft² | g/m² | Test |
| PG 270 starch Only | 7.81 | 2.86 | 4.67 | 1 |
| PG 270 starch + 0.18% zein/0.18% SDS | 8.18 | 2.91 | 4.74 | 1 |
| PG 270 starch + 0.90% zein/0.90% SDS | 9.09 | 2.96 | 4.82 | 6 |
| PG 270 starch + 1.80% zein/1.80% SDS | 10.29 | 2.88 | 4.84 | 7 |
| PG 380 starch Only | 7.29 | 2.82 | 4.53 | 1 |
| PG 380 starch + 0.18% zein/0.18% SDS | 7.70 | 3.00 | 4.88 | 1 |
| PG 380 starch + 0.90% zein/0.90% SDS | 8.81 | 2.88 | 4.70 | 7 |
| PG 380 starch + 1.80% zein/1.80% SDS | 10.19 | 3.12 | 5.08 | 8 |

The results show that the increase in percent solids may have had a large effect on the Kit test values and need to be tightly controlled. In Example 2, the level of total solids is held constant as relative amounts of the constituents were varied. The table indicates that as the level of zein and SDS is increased, the Kit test values also increase.

### EXAMPLE 3

Further testing held total starch solids constant and increased amounts of zein added to measure the change in Kit value with the results shown in Table 3 below.

TABLE 3

| | | Pickup | | Kit |
|---|---|---|---|---|
| | % | lbs/ | | Test |
| Formulation | Solids | 3000 ft² | g/m² | (pass) |
| PG 270 starch Only | 7.55 | 2.67 | 4.35 | 1 |
| PG 270 starch + 0.18% Zein/0.18% SDS | 7.77 | 2.69 | 4.38 | 1 |
| PG 270 starch + 0.36% Zein/0.36% SDS | 8.04 | 2.88 | 4.69 | 1 |
| PG 270 starch + 0.54% Zein/0.54% SDS | 8.1 | 3.08 | 5.02 | 2 |
| PG 270 starch + 0.72% Zein/0.72% SDS | 8.41 | 2.90 | 4.73 | 7 |
| PG 270 starch + 0.90% Zein/0.90% SDS | 8.59 | 3.19 | 5.20 | 8 |

### EXAMPLE 4

According to this example, further testing in accordance with the methods of Example 1 provided even more detailed information The weight % values illustrate the total composition quite well in Table 4 below. Antifoam B was added to the compositions at a 0.04% w/w level

TABLE 4

| | Pickup | % | Kit |
|---|---|---|---|
| Composition(weight to weight = w/w) | (g/m²) | Solids | Test |
| PG 270 Starch Only | 2.61 | 7.33 | 1 |
| PG 270 Starch + 0.1% SDS Only | 4.20 | 7.46 | 1 |
| PG 270 Starch + 0.5% SDS Only | 4.49 | 7.65 | 2 |
| PG 270 Starch + 1.0% SDS Only | 4.63 | 7.72 | 8 |
| PG 270 Starch + 0.51% Lot 1 Zein/0.51% SDS | 4.70 | 8.22 | 1 |
| PG 270 Starch + 0.68% Lot 1 Zein/0.68% SDS | 5.73 | 7.82 | 5 |
| PG 270 Starch + 0.85% Lot 1 Zein/0.85% SDS | 5.25 | 9.07 | 4 |
| PG 270 Starch + 0.46% Lot 2 Zein/0.46% SDS | 4.82 | 7.92 | 2 |
| PG 270 Starch + 0.61% Lot 2 Zein/0.61% SDS | 4.84 | 8.34 | 3 |
| PG 270 Starch + 0.77% Lot 2 Zein/0.77% SDS | 4.56 | 8.02 | 6 |
| PG 270 Starch + 0.30% Diluted Lot-1 Zein/0.30% | 4.73 | 8.00 | 1 |
| SDS | | | |
| PG 270 Starch + 0.30% Diluted Lot-2 Zein/0.30% | 4.62 | 7.99 | 2 |
| SDS | | | |
| PG 270-1 Starch | 4.32 | 12.46 | 1 |
| PG 270-2 Starch | 5.24 | 9.93 | 3 |
| PG 270-3 Starch | 4.20 | 7.97 | 3 |
| PG 270-4 Starch | 5.62 | 5.89 | 2 |
| PG 270-5 Starch | 4.08 | 3.96 | 1 |
| PG 270 Starch + 0.1 wt % SDS | 4.12 | 5.97 | 1 |
| PG 270 Starch + 0.25 wt % SDS | 4.95 | 6.18 | 1 |
| PG 270 Starch + 0.50 wt % SDS | 4.96 | 6.18 | 3 |
| PG 270 Starch + 1.01 wt % SDS | 5.48 | 6.53 | 6 |
| PG 270 Starch + 2.00 wt % SDS | 4.83 | 7.62 | 7 |
| PG 270 Starch + 4.02 wt % SDS | 5.15 | 9.59 | 7 |

These data showed the effect of SDS only on Kit test values with very low starch solids. Further work with this type of composition could lead to a lower zein content product but may require a large amount of antifoam to counteract the foaming capacity of SDS.

### EXAMPLE 5

Further testing evaluates the effect of zein/SDS/starch content at a much finer level of detail with the results shown in Table 5 below.

TABLE 5

| | | Pickup | | Kit |
|---|---|---|---|---|
| | % | lbs/ | | Test |
| Formulation | Solids | 3000 ft² | g/m² | (pass) |
| PG 270 starch only | 7.56 | 2.78 | 4.53 | 1 |
| PG 270 starch + 0.60% Zein/0.6% SDS | 8.55 | 2.71 | 4.31 | 3 |
| PG 270 starch + 0.75% Zein/0.75% SDS | 8.86 | 2.92 | 4.75 | 6 |
| PG 270 starch + 0.60% Zein/0.60% SDS | 8.78 | 2.81 | 4.57 | 3 |
| PG 270 starch + 0.60% Zein/0.60% SDS | 8.63 | 3.93 | 4.81 | 8 |
| PG 270 starch + 0.60% Zein/0.60% SDS | 8.57 | 2.88 | 4.68 | 8 |
| PG 270 starch + 0.75% Zein/0.75% SDS | 8.88 | 2.87 | 4.69 | 8 |
| PG 270 starch + 0.5% SDS | 7.87 | 2.71 | 4.41 | 5 |
| PG 270 starch + 0.75% SDS | 7.99 | 2.96 | 4.85 | 9 |

The various extracts used were at different solids levels and led to some scatter in the Kit test values. According to these experiments a preferred composition comprises about 7.5 g starch, 1.2 g zein, 1.2 g SDS per 100 g of total aqueous suspension. Preferred compositions of the invention comprise between 8 to 15% by weight zein/corn prolamine. Other preferred compositions of the invention comprise between 8 to 30% by weight Sodium Dodecyl Sulfate (SDS).

### EXAMPLE 6

According to a further example, analysis was carried out to determine the amount of composition that leads to a Kit value between 3 and 4 with the results shown in Table 6 below.

TABLE 6

| Composition | % Solids | Pickup | Kit Test |
|---|---|---|---|
| PG 270 starch only | 7.7 | 2.53 | 1 |
| PG 270 starch + 0.60% Zein/0.60% SDS + No AntiFoam | 8.22 | 2.96 | 4 |
| PG 270 starch + 0.60% Zein/0.60% SDS + 0.035% AntiFoam B | 8.28 | 2.92 | 3 |
| PG 270 starch + 0.60% Zein/0.60% SDS + 0.066% AntiFoam B | 8.43 | 2.74 | 3 |
| PG 270 starch + 0.60% Zein/0.60% SDS + 0.980% AntiFoam B | 8.32 | 2.73 | 3 |
| PG 270 starch + 0.60% Zein/0.60% SDS + No AntiFoam | 8.46 | 3.08 | 3 |
| PG 270 starch + 0.60% Zein/0.60% SDS + No AntiFoam | 8.11 | 2.85 | 3 |
| PG 270 starch + 0.60% Zein/0.60% SDS + 0.050% AntiFoam B | 8.28 | 3.10 | 4 |
| PG 270 starch + 0.5% SDS only w/w | 8.03 | 3.07 | 5 |
| PG 270 starch only repeat | 7.61 | 2.65 | 1 |
| PG 270 starch + 0.60% Zein/0.60% SDS + No Antifoam repeated | 8.1 | 2.77 | 4 |
| PG 270 starch + 0.60% Zein/0.60% SDS + No Antifoam | 7.86 | 2.64 | 2 |
| PG 270 starch + 0.60% Zein/0.60% SDS + No Antifoam | 8.16 | 2.69 | 2 |
| PG 270 starch + 0.60% Zein/0.60% SDS + 0.020% Antifoam B | 8.23 | 2.77 | 3 |
| PG 270 starch + 0.60% Zein/0.60% SDS Filtered | 8.15 | 3.15 | 3 |
| PG 270 starch + 0.60% Zein/0.60% SDS + 0.040% Antifoam B | 8.23 | 3.17 | 4 |
| PG 270 starch + 0.60% Zein/0.60% SDS + No Antifoam | 7.51 | 2.62 | 5 |
| PG 270 starch + 0.60% Zein/0.60% SDS + 0.050% AntiFoam | 7.64 | 2.53 | 5 |
| PG 270 starch + 0.5% SDS only w/w + 0.054% Antifoam B | 7.71 | 2.71 | 4 |

### EXAMPLE 7

According to this example, the effects of the combination of SDS surfactant with antifoam B and starch were compared with and without the presence of prolamine (zein).

TABLE 7
SDS Only and Low Zein Content Formulations

| | % | | Kit |
|---|---|---|---|
| Composition | Solids | Pickup | Test |
| PG 270 starch Only | 7.47 | 2.75 | 2 |
| PG 270 starch + 0.4% SDS + 0.02% Antifoam | 7.65 | 2.85 | 3 |
| PG 270 starch + 0.5% SDS + 0.02% Antifoam | 7.84 | 3.12 | 4 |
| PG 270 starch + 0.6% SDS + 0.02% Antifoam | 7.80 | 3.1 | 4 |
| PG 270 starch + 0.5% SDS + 0.05% Zein + 0.02% | 8.36 | 2.75 | 3 |
| Antifoam | | | |
| PG 270 starch + 0.4% SDS + 0.04% Antifoam | 7.67 | 3.36 | 4 |
| PG 270 starch + 0.5% SDS + 0.04% Antifoam | 7.82 | 3.08 | 4 |
| PG 270 starch + 0.6% SDS + 0.04% Antifoam | 7.74 | 2.76 | 5 |
| PG 270 starch + 0.5% SDS + 0.05% Zein + 0.04% | 8.47 | 2.73 | 5 |
| Antifoam | | | |

These results show that a prolamine might not be necessary to provide suitable properties to a coated substrate such as a size coated sheet.

### EXAMPLE 8

According to this example various surfactants were tested to determine their suitability for solubilizing zein. The results shown in Table 8 below suggest that only anionic surfactants with a certain carbon chain length may be suitable for solubilizing zein. It appears that HLB is a good indicator of whether or not zein would be soluble in a given surfactant with an HLB greater than 20 being preferred.

TABLE 8

| Sample | Compound | Zein Soluble |
|---|---|---|
| 1 | Sorbitan Oleate | No |
| 2 | Sodium Dodecyl Sulfate | Yes |
| 3 | Sodium Decanoate | Yes |
| 4 | Sodium Octanoate | No |
| 5 | Sodium Hexanoate | No |
| 6 | Sodium Stearic Acid | Partially |
| 7 | Sodium Benzoate | No |
| 8 | Dodecylbenzene Sulfonic Acid | Yes |
| 9 | 4-Styrenesulfonic Acid | No |
| 10 | 1-Octanesulfonic Acid | Yes |
| 11 | Dilute OSA-waxy Starch | No |
| 12 | Sodium Lactate | No |

An analysis of the preceding experiments suggests that defoamer concentrations greater than 0.05% w/w are not any more effective at lowering foaminess from the surfactants although no negative effects are seen at higher concentrations.

In addition lower prolamine (zein) levels do not seem to affect Kit values as much as lower surfactant (SDS) levels do. It thus appears that the surfactant plays a larger role that the prolamine in providing for a suitable coating result.

### EXAMPLE 9

According to this example a coating composition was produced comprising glyoxal crosslinking agent and zein isolated from corn gluten meal. Dried corn gluten meal was screened and 500-850 micron sized meal recovered. Zein was extracted with an ethanol/water solution and recovered at an ˜8.5% dry solids basis. Sodium hydroxide was added at ˜3% NaOH w/w of zein dsb extract and glyoxal was then added at a 0.5-1.0:1.0 w/w ratio to zein and the mixture was held for 1 hour at 60° C. with agitation at a pH between 7-8. Sodium dodecyl sulfate was added at a 1.1:1.0 w/w ratio to the zein and the mixture was agitated and evaporated until 20% ds is achieved. The resulting product can be filtered and centrifuged to remove undesired solids.

### EXAMPLE 10

According to this example, coating compositions having differing proportions of zein-glyoxal blends (99/1 or 95/5 (as is)) were combined with different proportions with Penford Gum 270 ethylated starch at approximately 7% solids with and used to coat sheets according to the method of Example 1. The formulations were mixed and held at 70° C. during draw downs and the drawdown machine speed was set at 4.0 with a stroke length of 12 inches. The rod used was changed as needed to achieve the desired pickup of 2.5-3.5 dry grams per 3000 square feet. The resulting coated sheets were dried on a hot plate set to 65° C.

Kit testing was conducted on three sheets, at coat weight for each formulation. The value reported in Table 9 below is the highest numbered test solution that passed consistently i.e. that is a minimum of three out of four drops on a given sheet.

TABLE 9

| | | | Average | |
|---|---|---|---|---|
| | Glyoxal:Prolamine | Starch:Active | Pickup | Kit Test |
| Sample | Ratio | Ratio | (lbs/3000 ft²) | Results |
| 9.1 | 1:1 | 99:1 | 3.26 | 8 |
| | 1:1 | 95:5 | 2.98 | 9 |
| 9.2 | 0.5:1 | 99:1 | 3.41 | 8 |
| | 0.5:1 | 95:5 | 3.03 | 7 |
| 9.3 | 0.25:1 | 99:1 | 2.92 | 7 |
| | 0.25:1 | 95:5 | 2.86 | 6 |
| 9.4 | 1:1 | 99:1 | 2.89 | 5 |
| | 1:1 | 95:5 | 2.61 | 6 |
| 9.5 | 1:1 | 99:1 | 2.83 | 7 |
| | 1:1 | 95:5 | 3.00 | 11 |
| 9.6 | 2:1 | 99:1 | 3.09 | 7 |
| | 2:1 | 95:5 | 2.78 | 10 |
| 9.7 | 3:1 | 99:1 | 3.33 | 9 |
| | 3:1 | 99:5 | 3.30 | 12 |

### EXAMPLE 11

According to this example, coating compositions were made from mixing Penford® Gum 270 paste, at approximately 7% solids, with glyoxal-prolamine blends at ratios of 99:1 (as is) and were used to draw coat sheets at different glyoxal to zein ratios. The formulations were mixed and held at 70° C. during draw downs and the drawdown machine speed was set at 4.0 with a stroke length of 12 inches. The rod used was changed as needed to achieve the desired pickup of 2.5-3.5 dry grams per 3000 square feet and the coated sheets were dried on a hot plate set to 65° C.

Kit testing was conducted on three sheets, at coat weight for each formulation. The value reported in Table 10 below is the highest numbered test solution that passed consistently i.e. that is a minimum of three out of four drops on a given sheet. The data show that the compositions of the invention are comparable to and superior to commercially available fluorochemical grease barrier compounds Cartafluor® and Solvera® PT5045 applied at comparable pickups.

TABLE 10

| | | Average Pickup | Kit Test |
|---|---|---|---|
| Sample | Glyoxal:Prolamine | (lbs/3000 ft²) | Results |
| 10.1 | 0.1:1 | 2.99 | 3 |
| 10.2 | 0.2:1 | 2.99 | 3 |
| 10.3 | 0.3:1 | 2.94 | 5 |
| 10.4 | 0.4:1 | 2.72 | 5 |
| 10.5 | 0.6:1 | 3.13 | 6 |
| 10.6 | 0.8:1 | 2.89 | 7 |
| 10.7 | 1:1 | 3.00 | 7 |
| 10.8 | 1:1 | 2.78 | 7 |
| Cartafluor ® | | 3.18 | 3 |
| Solvera ® | | 3.23 | 4 |
| PT5045 | | | |

### EXAMPLE 12

According to this example, coating compositions were made from mixing Penford Gum 270 paste, at approximately 7% solids, with glyoxal-prolamine blends at ratios of 99/1 (as is) and were used to draw coat sheets at different glyoxal to zein ratios. The formulations were mixed and held at 70° C. during draw downs and the drawdown machine speed was set at 4.0 with a stroke length of 12 inches. The rod used was changed as needed to achieve the desired pickup of 2.5-3.5 dry grams per 3000 square feet and the coated sheets were dried on a hot plate set to 65° C.

Kit testing was conducted on three sheets, at coat weight for each formulation. The value reported in Table 11 below is the highest numbered test solution that passed consistently i.e. that is a minimum of three out of four drops on a given sheet.

TABLE 11

| | % Glyoxal | Average Pickup | Kit Test |
|---|---|---|---|
| Sample | (w/w % Zein) | (lbs/3000 ft²) | Results |
| 11.1 | 1:1 | 2.85 | 11 |
| 11.2 | 1:1 | 2.79 | 8 |
| 11.3 | 0.5:1 | 2.95 | 7 |
| 11.4 | 0.5:1 | 3.05 | 6 |
| 11.5 | 0.5:1 | 2.85 | 5 |
| 11.6 | 0.5:1 | 2.68 | 5 |

### EXAMPLE 13

According to this example, phosphorus oxychloride POCl₃ was used to crosslink zein and the resulting crosslinked zein was combined at various ratios with Penford® Gum 270 ethylated starch at approximately 7% solids with and used to coat sheets according to the methods of claim 1. The formulations were mixed and held at 70° C. during draw downs and the drawdown machine speed was set at 4.0 with a stroke length of 12 inches. The rod used was changed as needed to achieve the desired pickup of 2.5-3.5 dry grams per 3000 square feet. The resulting coated sheets were dried on a hot plate set to 65° C.

Kit testing was conducted on three sheets, at coat weight for each formulation. The value reported in Table 12 below is the highest numbered test solution that passed consistently i.e. that is a minimum of three out of four drops on a given sheet.

TABLE 12

| | Starch:Active | Average Pickup | Kit Test |
|---|---|---|---|
| Sample | Ratio | (lbs/3000 ft²) | Results |
| 0.25:1 | 99:1 | 3.12 | 3 |
| POCl₃:Zein w/w | 98:2 | 3.29 | 3 |
| | 95:5 | 3.06 | 3 |
| Solvera ® PT 5045 | 99:1 | 3.16 | 4 |
| | 95:5 | 2.7 | 8 |

### EXAMPLE 14

According to this example, gluteraldehyde was used to crosslink zein and the resulting crosslinked zein was combined at various ratios with Penford® Gum 270 ethylated starch at approximately 7% solids with and used to coat sheets according to the methods of claim 1. The formulations were mixed and held at 70° C. during draw downs and the drawdown machine speed was set at 4.0 with a stroke length of 12 inches. The rod used was changed as needed to achieve the desired pickup of 2.5-3.5 dry grams per 3000 square feet. The resulting coated sheets were dried on a hot plate set to 65° C. Kit testing was conducted on three sheets, at coat weight for each formulation.

The zein formulations were pale yellowish white at a starch to active ratio of 99:1. When the ratio was increased to 95/5, the color of the formulation became a brighter yellow. However, no color was observed on the coated sheets. The value reported in Table 13 below is the highest numbered test solution that passed consistently i.e. that is a minimum of three out of four drops on a given sheet.

TABLE 13

| | “Active” | | Average | |
|---|---|---|---|---|
| | Glutaraldehyde: | Starch:Active | Pickup | Average Kit |
| Sample | Zein Ratio | Ratio | (lb/3000 ft²) | Value |
| 13.1 | 0.1:1 | 99:1 | 3.02 | 2 |
| | 0.1:1 | 95:1 | 2.95 | 4 |
| 13.2 | 0.5:1 | 99:1 | 2.96 | 3 |
| | 0.5:1 | 95:1 | 2.88 | 4 |
| 13.3 | 1.0:1 | 99:1 | 2.74 | 3 |
| | 1.0:1 | 95:1 | 3.18 | 5 |
| Solvera ® | | 99:1 | 3.03 | 5 |
| | | 95:1 | 2.87 | 7 |

These results show that the gluteraldehyde treated prolamine produces a product with superior oil and grease resistant properties compared with POCl₃ crosslinked prolamine but still not as good as glyoxal treated prolamine.

It is anticipated that numerous variations and modification of the embodiments of the invention described above will occur to those of ordinary skill in the art when apprised of the teachings of the present specification. Accordingly, only such limitations as appear in the appended claims should be placed thereon.

What is claimed:

1. A coating composition comprising from 5-15% by weight prolamine, from 5 to 15% by weight surfactant and from 70-90% by weight water.

2. The coating composition of claim 1 wherein the prolamine is zein.

3. The coating composition of claim 1 wherein the surfactant is an anionic surfactant.

4. The coating composition of claim 1 wherein the surfactant is sodium dodecyl sulfate (SDS).

5. The coating composition of claim 1 further comprising a polysaccharide.

6. The coating composition of claim 1 wherein the starch is modified with ethylene or propylene oxide.

7. The coating composition of claim 1 further comprising a crosslinking agent.

8. The coating composition of claim 1 further comprising glyoxal.

9. A method of coating a substrate comprising the step of applying a coating composition comprising from 5-15% by weight prolamine, from 5 to 15% by weight surfactant and from 70-90% by weight water in further combination with a polysaccharide.

10. The method of claim 9 wherein the prolamine is zein.

11. The method of claim 9 wherein the surfactant is an anionic surfactant.

12. The method of claim 9 wherein the surfactant is sodium dodecyl sulfate (SDS).

13. The method of claim 9 wherein the polysaccharide is starch is modified with ethylene or propylene oxide.

14. The method of claim 9 wherein the substrate is selected from the group consisting of paper, paper board, wood, inorganic substrates and textile products.

15. The method of claim 9 wherein the substrate is paper and the sizing composition is applied at the wet end of the paper making process.

16. The method of claim 9 wherein the coating formulation is applied on a size press.

17. The method of claim 9 wherein the coating formulation further comprises a crosslinking agent.

18. The method of claim 9 wherein the coating composition further comprises glyoxal.

19. A coated substrate produced according to the method of claim 9.

20. A method of coating a substrate comprising the step of applying a coating composition comprising from 5 to 30% by weight surfactant and from 70 to 95% by weight water in further combination with a polysaccharide.

21. The method of claim 20 wherein the polysaccharide is starch.

22. The method of claim 20 wherein the surfactant is an anionic surfactant.

23. The method of claim 22 wherein the surfactant is sodium dodecyl sulfate (SDS).

24. A coated substrate produced according to the method of claim 20.
